(19) United States
(12) Patent Application Publication
(10) Pub. No.: US 2026/0277183 A1
(43) Pub. Date: Sep. 17, 2026

(54) NUMERICAL CONTROL DEVICE AND NUMERICAL CONTROL SYSTEM

(71) Applicant: FANUC CORPORATION, Yamanashi (JP)

(72) Inventor: Kazutaka IMANISHI, Yamanashi (JP)

(73) Assignee: FANUC CORPORATION, Yamanashi (JP)

(21) Appl. No.: 18/871,982

(22) PCT Filed: Aug. 25, 2022
(86) PCT No.: PCT/JP2022/032056

§ 371 Date: Dec. 5, 2024

(51) Int. Cl. G05B 19/4061; B25J 9/16

(52) U.S. Cl. CPC G05B 19/4061; B25J 9/1676; G05B 2219/40476

(57) ABSTRACT

Provided are a numerical control device and a numerical control system that can prevent collision between a robot and a machine tool during operation of the robot using a numerical control program. This numerical control device comprises: a safe motion setting selection unit that, when the robot numerical control command includes a safe motion setting, selects the safe motion setting in the robot numerical control command and reads safe motion setting information corresponding to the safe motion setting; and a robot command signal generation unit that generates a robot command signal on the basis of the robot numerical control command and the safe motion setting information. The robot command signal corresponding to the safe motion setting information is outputted to a robot control device that controls the robot. The safe motion setting is reflected in the motion of the robot by the robot control device.

### TECHNICAL FIELD

The present invention relates a numerical control device and a numerical control system.

### BACKGROUND ART

In recent years, in order to promote the automation of machining sites, a numerical control system has been demanded which controls interlocking operation of a machine tool that machines a workpiece, and operation of a robot provided in the vicinity of this machine tool has been demanded (for example, refer to Patent Documents 1 and 2).

In addition, in a numerical control system, a function providing limitations to the motion range, speed, etc. of the robot in order to prevent a robot from colliding with the machine tool has also been known.

### CITATION LIST

### Patent Document

Patent Document 1: Japanese Unexamined Patent Application, Publication No. 2016-143273

Patent Document 2: Japanese Patent No. 5752179

### DISCLOSURE OF THE INVENTION

### Problems to Be Solved by the Invention

The aforementioned such numerical control system can select the coordinate system serving as a base on the numerical control program, and write movement commands for the robot. However, the numerical control system applies settings selected in advance for the limitations of the motion range, speed, etc. of the robot.

In the case of the robot performing operation outside or inside of the machine tool, or a case of performing operation on a plurality of machine tools, the numerical control system cannot change the limitations for the motion range, speed, etc. according to the situation. For this reason, there is a risk of the robot colliding with a machine tool, by incorrect operation or a programming glitch during running of the robot according to the numerical control program.

A numerical control device and numerical control system have been desired which can prevent collision between the robot and machine tool during running of the robot using the numerical control program.

### Means for Solving the Problems

An aspect of the present disclosure is directed to a numerical control device for executing a numerical control program for controlling operations of a machine tool and a robot, the numerical control device including: an analyzer which analyzes a robot numerical control command in the numerical control program; a safe operation setting selector which, in a case of the robot numerical control command analyzed by the analyzer including a safe operation setting, selects the safe operation setting in the robot numerical control command, and reads safe operation setting information corresponding to the safe operation setting; and a robot command signal generator which generates a robot command signal, based on the robot numerical control command and the safe operation setting information, in which the robot command signal corresponding to the safe operation setting information is outputted a robot control device controlling the robot, and the safe operation setting is reflected in operation of the robot by the robot control device.

An aspect of the present disclosure is directed to a numerical control system including a numerical control device which executes a numerical control program for controlling operations of a machine tool and a robot, and a robot control device which controls the robot based on the numerical control program, the numerical control device including: an analyzer which analyzes a robot numerical control command in the numerical control program; a safe operation setting selector which, in a case of the robot numerical control command analyzed by the analyzer including a safe operation setting, selects the safe operation setting in the robot numerical control command, and reads safe operation setting information corresponding to the safe operation setting; and a robot command signal generator which generates a robot command signal based on the robot numerical control command and the safe operation setting information, in which the robot control device includes: an input analyzer which analyzes the robot command signal inputted from the numerical control device; a safe operation setting update controller which, in a case of the robot command signal analyzed by the input analyzer including a signal corresponding to the safe operation setting information, updates a safe operation setting of the robot, based on the signal corresponding to the safe operation setting information; and a servo controller which, if detecting operation of the robot deviating from the safe operation setting which was updated, executes processing of decelerating or stopping a servo motor of the robot.

### BRIEF DESCRIPTION OF THE DRAWINGS

FIG. 1 is a schematic diagram of a numerical control system according to the present embodiment;

FIG. 2 is a functional block diagram for a numerical control device and a robot control device;

FIG. 3 is a chart showing an example of safe movement setting information;

FIG. 4 is a view showing a first example of a numerical control program;

FIG. 5 is a sequence diagram showing the flow of signals, information, etc. based on the numerical control program shown in FIG. 4; and

FIG. 6 is a view showing a second example of a numerical control program.

### PREFERRED MODE FOR CARRYING OUT THE INVENTION

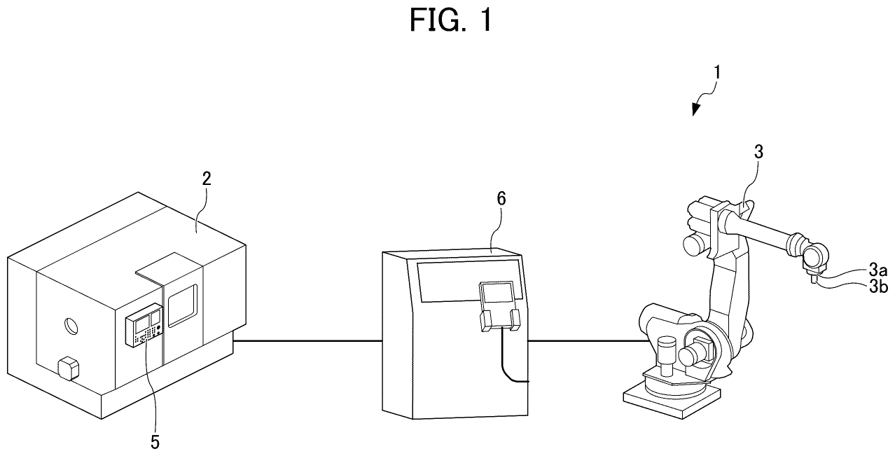

Hereinafter, an example of an embodiment of the present disclosure will be described. FIG. 1 is a schematic diagram of a numerical control system 1 according to the present embodiment.

The numerical control system 1 includes: a machine tool 2 which machines a workpiece (not shown), a numerical control device (CNC) 5 which controls operation of this machine tool 2; a robot 3 provided in the vicinity of the machine tool 2; and a robot control device 6 which controls operation of the robot 3. The numerical control system 1 controls operations of the machine tool 2 and robot 3 to be interlocked with each other, by using the numerical control device 5 and the robot control device 6 which are communicably connected with each other.

The machine tool 2 machines a workpiece (not shown) according to machine tool control signals sent from the numerical control device 5. Herein, the machine tool 2, for example, is a lathe, a ball mill, a milling machine, a grinding machine, a laser processing machine, an injection molding machine, and the like; however, it is not limited to these.

The robot 3 operates under the control by the robot control device 6, and performs a predetermined operation on a workpiece to be machined by the machine tool 2, for example.

The robot 3 is, for example, an articulated robot, and a tool 3b for gripping, machining, or inspecting a workpiece is attached to an arm tip portion 3a thereof. Hereinafter, a case where the robot 3 is a six-axis articulated robot will be described; however, it is not limited thereto. In addition, hereinafter, a case of the robot 3 being a six-axis articulated robot will be described: however, the number of axes is not limited thereto.

The numerical control device 5 and the robot control device 6 are each a computer configured by hardware such as an arithmetic processing unit such as a CPU (Central Processing Unit), an auxiliary storage unit such as an HDD (Hard Disk Drive) and/or an SSD (Solid State Drive) storing various computer programs, a main storage unit such as RAM (Random Access Memory) for temporarily storing data necessary for the arithmetic processing unit to execute a computer program, an operation unit such as a keyboard on which an operator performs various operations, and a display unit such as a display for displaying various information to the operator.

This robot control device 6 and numerical control device 5 enable transmission and reception of various signals to and from each other by way of the Ethernet (registered trademark), for example.

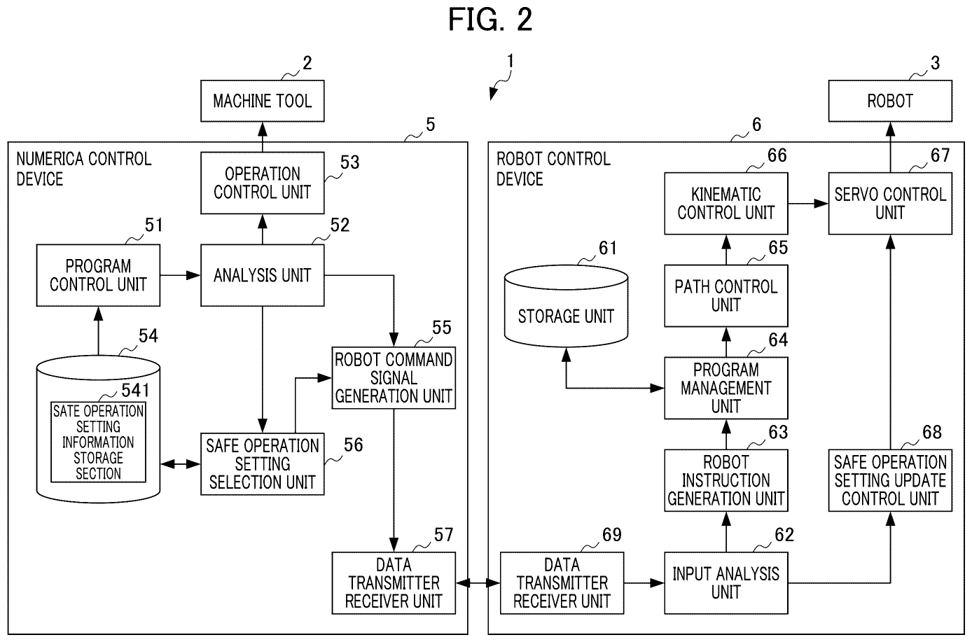

FIG. 2 is a functional block diagram of the numerical control device 5 and the robot control device 6. First, the detailed configuration of the numerical control device 5 will be described. As shown in FIG. 2, the numerical control device 5 realizes various functions such as a function of controlling operation of the machine tool 2, and a function of generating a motion path of control axes of the robot 3, by way of the above hardware configuration.

The numerical control device 5 generates various commands for controlling operation of the robot 3 and the tool 3b in accordance with the numerical control program for the robot, and sends these to the robot control device 6. More specifically, the numerical control device 5 includes: a program input unit 51, an analysis unit 52, an operation control unit 53, a storage unit 54, a robot command signal generation unit 55, a safe operation setting selection unit 56, and a data transmitter receiver unit 57.

The program input unit 51 reads out the numerical control program for the robot configured by a plurality of robot command blocks from the storage unit 54, and inputs this sequentially to the analysis unit 52.

The analysis unit 52 analyzes the command classification for every command block based on the numerical control program inputted from the program input unit 51, and outputs this analysis result to the operation control unit 53 and the robot command signal generation unit 55. More specifically, the analysis unit 52, in the case of the command classification of the command block being a machine tool numerical control command for the machine tool 2, sends this machine tool numerical control command to the operation control unit 53. The analysis unit 52, in the case of the command classification of the command block being a robot numerical control command for the robot 3, outputs this robot numerical control command to the robot command signal generation unit 55.

The operation control unit 53 generates a machine tool control signal for controlling operation of the machine tool 2 according to the analysis result sent from the analysis unit 52, and inputs to the actuators driving various axes of the machine tool 2. The machine tool 2 operates according to the machine tool control signals inputted from the operation control unit 53 to machine a workpiece (not shown).

The storage unit 54, for example, saves a plurality of numerical control programs created based on manipulations by the operator. More specifically, the storage unit 54 saves the numerical control program configured by a plurality of command blocks for the machine tool 2 in order to control operation of the machine tool 2, a plurality of command blocks for the robot 3 in order to control operation of the robot 3, etc. The numerical control program saved in the storage unit 54 is written in a known programming language for controlling the operation of the machine tool 2, such as G code or M code.

In addition, the storage unit 54, for example, saves machine coordinate values indicating the position of various axes of the machine tool 2 (i.e. position of the tool post, table, etc. of the machine tool 2) which operates under the above-mentioned numerical control program. It should be noted that these machine coordinate values are defined under the machine tool coordinate system with a reference point decided at any position on the machine tool 2 or in the vicinity of the machine tool 2 as the origin. The latest values of the machine coordinate values, which sequentially change under the numerical control program, are sequentially updated by processing (not shown) so as to be stored in the storage unit 54.

In addition, the storage unit 54 stores the position and posture of the control points of the robot 3 operating under the control of the robot control device 6 (e.g., arm tip end 38 of the robot 3), in other words, the robot coordinate values indicating the position of each control axis of the robot 3. It should be noted that these robot coordinate values are defined under a robot coordinate system different from the machine tool coordinate system as mentioned above. The latest values of the robot coordinate values, which sequentially change under the numerical control program, are sequentially updated according to the robot coordinate values acquired from the robot control device 6 by processing (not shown) so as to be stored in the storage unit 54.

In addition, the storage unit 54, for example, stores teaching positions such as a start point and end point of the robot 3 inputted by the operator. More specifically, the storage unit 54 stores the teaching positions of the robot 3 inputted from a teach pendant or the like, the teaching positions, inputted from a keyboard or the like, etc. The robot coordinate values indicating each control axis of the robot 3 are included in the teaching points of the robot 3, and these robot coordinate values are defined under the robot coordinate system, which differs from the machine tool coordinate system.

Furthermore, the storage unit 54 includes a safe operation setting information storage section 541 which stores safe operation setting information.

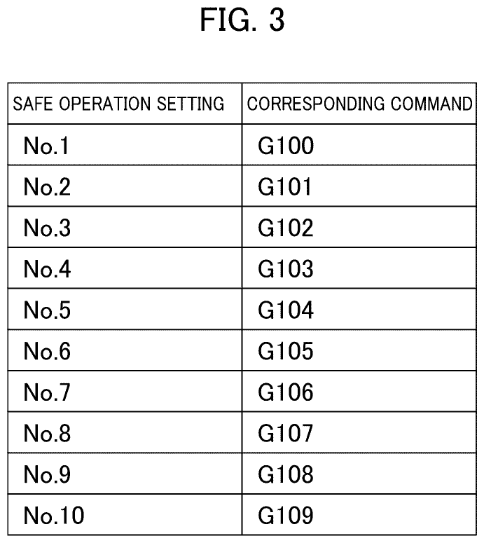

FIG. 3 is a drawing showing an example of the safe operation setting information. As shown in FIG. 3, the safe operation setting information is stored in the safe operation setting information storage section 541 in which a safe operation setting and a command corresponding to the safe operation setting are associated. Specifically, safe operation settings No. 1 to No. 10 are respectively stored to be associated with robot numerical control commands G100 to G109.

The safe operation setting, for example, may include at least one among a motion range of the robot 3, a 3D model of the robot 3 including an end effector, and a maximum operating speed of the robot 3. In addition, the safe operation setting, for example, may be a setting number, a geometric model of the robot 3, region information of the robot 3 (for example, inside and outside of a safety fence, etc.), maximum speed limit, movement restrictions, etc.; however, it is not limited to these.

In addition, the safe operation setting information according to the present embodiment is stored in the safe operation setting information storage section provided to the numerical control device 5; however, the safe operation setting information may be stored in the safe operation setting information storage section provided to any one of the numerical control device 5, robot control device 6, or outside of the numerical control device 5 and robot control device 6.

For example, the safe operation setting information may be stored in the storage unit 61 of the robot control device 6, or may be stored in a computer outside of the numerical control device 5 and robot control device 6, an external storage device, an external storage medium, a cloud computer, or the like.

Referring back to FIG. 2, the robot command signal generation unit 55 generates a robot command signal for every robot command block based on analysis results for every robot command block inputted from the analysis unit 52, and writes the generated robot command signals into the data transmitter receiver unit 59.

Specifically, the robot command signal generation unit 55 generates a robot command signal for every robot command block based on the robot numerical control command as an analysis result inputted from the analysis unit 52, and writes the generated robot command signal in the data transmitter receiver unit 59.

In addition, the robot command signal generation unit 55, in the case of the safe operation setting information being read from the safe operation setting information storage section 541, generates a robot command signal for every robot command block based on the robot numerical control command and the safe operation setting information as the analysis results, and writes the generated robot command signals into the data transmitter receiver unit 57.

The safe operation setting selection unit 56 selects a safe operation setting of the robot numerical control command, in the case of the robot numerical control command analyzed by the analysis unit 52 including the safe operation setting. Then, the safe operation setting selection unit 56 reads the safe operation setting information corresponding to the safe operation setting from the safe operation setting information storage section 541, and outputs the safe operation setting information to the robot command signal generation unit 55.

The robot command signal corresponding to the safe operation setting information is thereby outputted to the robot control device 6 controlling the robot 3, and the safe operation setting is reflected in the operation of the robot 3 by the robot control device 6.

The data transmitter receiver unit 57 sends and receives various data such as commands, robot coordinate values, etc. with the data transmitter receiver unit 69 of the robot control device 6. Specifically, the data transmitter receiver unit 57 sends the robot command signal generated by the robot command signal generation unit 55 to the data transmitter receiver unit 69 of the robot control device 6.

Next, the configuration of the robot control device 6 will be described in detail. As shown in FIG. 2, in the robot control device 6, various functions are realized by way of the above-mentioned hardware configuration such as of a storage unit 61, input analysis unit 62, robot instruction generation unit 63, program management unit 64, path control unit 65, kinematics control unit 66, servo control unit 67, safe operation setting update control unit 68 and data transmitter receiver unit 69. The robot control device 6 controls operation of the robot 3, based on commands sent from the numerical control device 5, by using this storage unit 61, input analysis unit 62, robot instruction generation unit 63, program management unit 64, path control unit 65, kinematics control unit 66, servo control unit 67, safe operation setting update control unit 68 and data transmitter receiver unit 69.

The data transmitter receiver unit 69 receives the robot command signals sent from the data transmitter receiver unit 57 of the numerical control device 5. In addition, the data transmitter receiver unit 69 sequentially outputs the received robot command signals to the input analysis unit 62.

The input analysis unit 62 analyzes the robot command signals inputted from the data transmitter receiver unit 69. In addition, the input analysis unit 62 outputs the analysis results thereof to the robot instruction generation unit 63.

The robot instruction generation unit 63 generates a robot instruction according to the robot command signal, based on the analysis results of the robot command signals inputted from the input analysis unit 62. The robot instruction generation unit 63 outputs the generated robot instructions to the program management unit 64.

When a robot instruction is inputted from the robot instruction generation unit 63, the program management unit 64 generates an operation plan of the robot 3 according to the above-mentioned robot command signals, by sequentially executing the robot instruction, and outputs this to the path control unit 65.

In addition, the program management unit 64, in the case of the robot instruction inputted from the robot instruction generation unit 63 being a block robot instruction, adds the inputted block robot instruction to the robot program saved in the storage unit 61. A robot program according to the robot command signals sent from the numerical control device 5 is thereby generated and stored in the storage unit 61. The stored robot program is started and reproduced by the program management unit 64 receiving a robot program startup command as a robot instruction.

The path control unit 65, when the operation plan is inputted from the program management unit 64, calculates time-series data of control points of the robot 3, and outputs this to the kinematics control unit 66.

The kinematics control unit 66 calculates target angles of each joint of the robot 3 from the inputted time series data, and inputs these to the servo control unit 67.

The servo control unit 67 generates the robot control signals for the robot 3, by feedback controlling each servo motor of the robot 3 so that the target angles inputted from the kinematics control unit 66 are realized, and inputs these to the servomotors of the robot 3.

The safe operation setting update control unit 68, in the case of the robot command signals analyzed by the input analysis unit 62 including a signal corresponding to the safe operation setting information, updates the safe operation settings of the robot 3 based on the robot command signal corresponding to the safe operation setting information, and notifies the servo control unit 67 about the updated safe operation settings. In this case, the servo control unit 67 generates a robot control signal including the safe operation setting, and inputs these to the servo motors of the robot 3.

The servo control unit 67, when detecting operation of the robot 3 deviating from the safe operation settings updated by the safe operation setting update control unit 68, executes processing to decelerate or stop the servomotors of the robot 3. The robot 3 can thereby perform operation reflecting the safe operation settings.

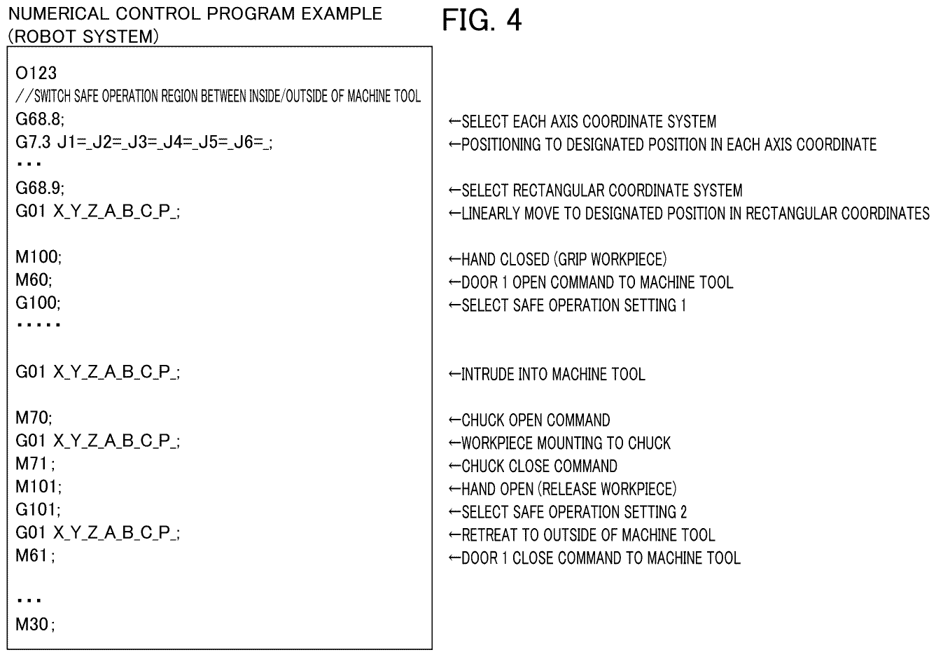

FIG. 4 is a drawing showing a first example of a numerical control program. The numerical control program shown in FIG. 4 includes the aforementioned such robot numerical control commands. The numerical control program switches the safe operation settings of the robot 3 between inside and outside of the machine tool 2. The safe operation region of the robot 3 is thereby switched between inside and outside of the machine tool 2.

Specifically, in the numerical control program shown in FIG. 4, from code “G68.8” to code “M60” are robot numerical control commands for operating the robot 3 outside of the machine tool 2. Then, code “G100” is a command for selecting the safe operation setting No. 1 as shown in FIG. 3.

Subsequently, from code “G01” to “M101” are robot numerical control commands for operating the robot 3 inside of the machine tool 2. Then, code “G101” is a command for selecting the safe operation setting No. 2 as shown in FIG. 3.

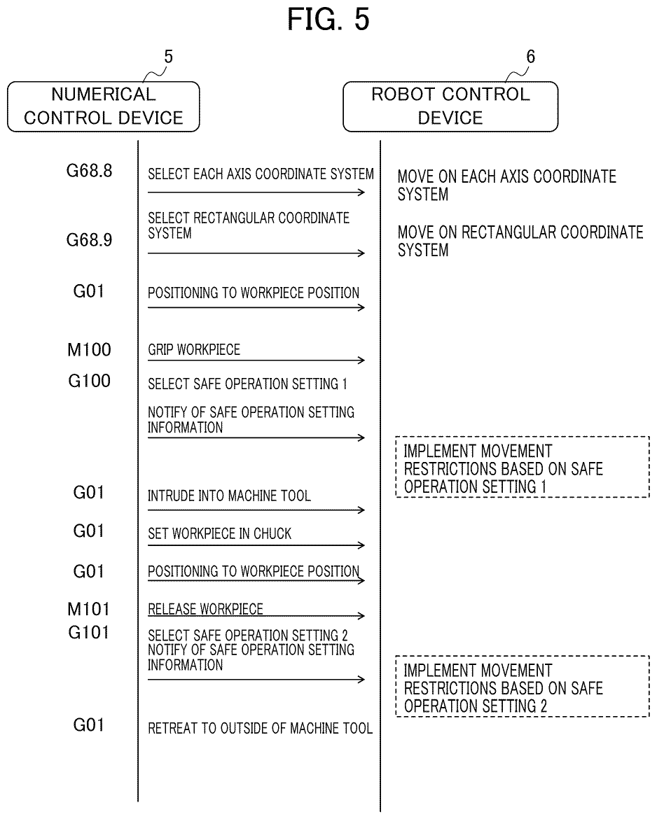

FIG. 5 is a sequence diagram showing the flow of signals and information between the numerical control device 5 and the robot control device 6 in the case of operating the numerical control device 5 based on the numerical control program shown in FIG. 4.

In the numerical control device 5, when the safe operation setting selection unit 56 selects the safe operation setting No. 1, the robot command signal generation unit 55 reads the safe operation setting information corresponding the safe operation setting No. 1 from the safe operation setting information storage section 541, and generates the robot command signal for every robot command block, based on the robot numerical control command and the safe operation setting information. The data transmitter receiver unit 57 notifies (sends) the robot control device 6 about the robot command signal corresponding to the safe operation setting information.

When the data transmitter receiver unit 69 of the robot control device 6 receives the robot command signal, the input analysis unit 62 analyzes the robot command signals. The safe operation setting update control unit 68 updates the safe operation settings of the robot 3 based on the robot command signals corresponding to the safe operation setting information, and notifies the servo control unit 67 about the updated safe operation settings. The robot control device 6 can thereby implement the movement restrictions of the robot 3 based on the safe operation setting No. 1 for outside of the machine tool 2.

Similarly, when the safe operation setting selection unit 56 selects the safe operation setting No. 2, the robot command signal generation unit 55 reads the safe operation setting information corresponding to the safe operation setting No. 2 from the safe operation setting information storage section 541, and generates robot command signals for every robot command block, based on the robot numerical control commands and the safe operation setting information. The data transmitter receiver unit 57 notifies (sends) the robot control device 6 about the robot command signal corresponding to the safe operation setting information.

When the data transmitter receiver unit 69 of the robot control device 6 receives the robot command signal, the input analysis unit 62 analyzes the robot command signal. The safe operation setting update control unit 68 updates the safe operation settings of the robot 3 based on the robot command signal corresponding to the safe operation setting information, and notifies the servo control unit 67 about the updated safe operation settings. The robot control device 6 can thereby implement the movement restriction of the robot 3 based on the safe operation setting No. 2 for inside of the machine tool 2. The safe operation settings of the robot 3 can switch between inside and outside of the machine tool 2 in this way.

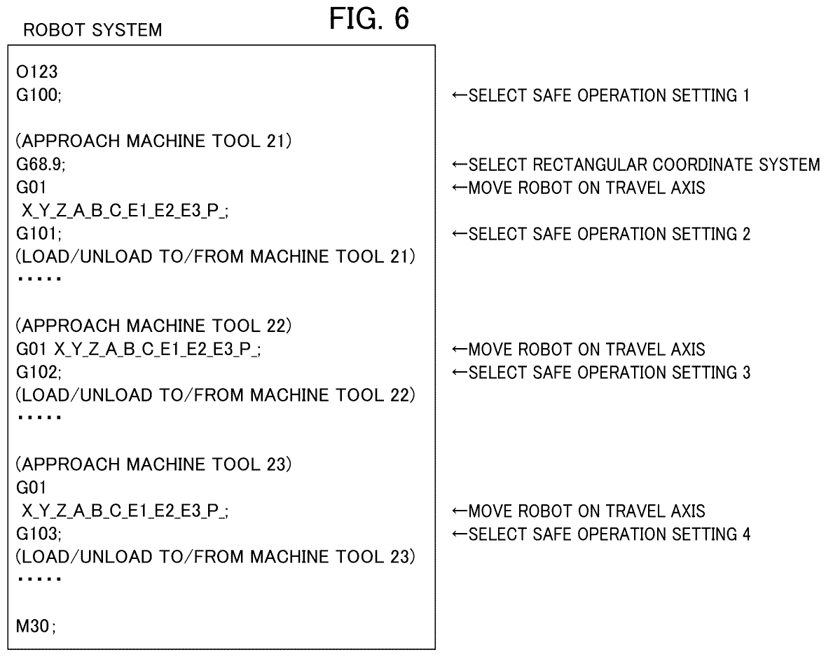

FIG. 6 is a drawing showing a second example of a numerical control program. The numerical control program shown in FIG. 6 includes the aforementioned such robot numerical control commands. The robot numerical control commands shown in FIG. 6, in the case of a plurality of machine tools 21, 22 and 23 being present, cause the robot 3 to move to the plurality of machine tools 2, and the safe operation settings are switched according to the plurality of machine tools 21, 22 and 23. It should be noted that, in the example shown in FIG. 6, the robot 3 is capable of moving between the plurality of machine tools 21, 22 and 23 according to the travel axis of the robot 3.

Specifically, in code “G100” of FIG. 6, the safe operation setting selection unit 56 selects the safe operation setting No. 1 of the robot numerical control commands. The robot numerical control commands, after selecting the safe operation setting No. 1, causes the robot 3 to approach (move to) the machine tool 21, by the travel axis of the robot 3. Then, in code “G101”, the safe operation setting selection unit 56 selects the safe operation setting No. 2 of the robot numerical control commands.

In addition, the robot numerical control command causes the robot 3 to approach (move to) the machine tool 22, by the travel axis of the robot 3, after selecting the safe operation setting No. 2. Then, in code “G102”, the safe operation setting selection unit 56 selects the safe operation setting No. 3 of the robot numerical control commands.

In addition, the robot numerical control command causes the robot 3 to approach (move to) the machine tool 23, by the travel axis of the robot 3, after selecting the safe operation setting No. 3. Then, in code “G103”, the safe operation setting selection unit 56 selects the safe operation setting No. 4 of the robot numerical control commands.

In this way, the robot numerical control command may cause the robot 3 to move to a plurality of work targets, and the safe operation setting may be switched according to the plurality of work targets. It should be noted that the example of FIG. 6 uses the plurality of machine tools 21, 22 and 23 as a plurality of control targets; however, the plurality of control targets are not limited to these, and may be other robots, other machine tools, other controllers, etc., for example.

According to the present embodiment as described above, the numerical control device 5 includes the analysis unit 52 which analyzes a robot numerical control command in the numerical control program; the safe operation setting selection unit 56 which, in a case of the robot numerical control command analyzed by the analysis unit 52 including a safe operation setting, selects a safe operation setting of the robot numerical control command, and reads the safe operation setting information corresponding to the safe operation setting; and the robot command signal generation unit 55 which generates a robot command signal based on the robot numerical control command and the safe operation setting information, in which the robot command signal corresponding to the safe operation setting information is outputted to the robot control device 6 controlling the robot 3, and the safe operation setting is reflected in the operation of the robot 3 by the robot control device 6.

The numerical control device 5 according to the present embodiment can change the limitation settings such as the motion range and speed of the robot 3 according to the situation, by selecting the safe operation settings of the robot 3, based on the robot numerical control commands in the numerical control program. Therefore, the numerical control device 5 can prevent collision between the robot 3 and the machine tool 2 due to misoperation, a programming glitch or the like, during running of the robot 3 by the numerical control program.

In addition, the safe operation settings may be switched between inside and outside of the machine tool 2. Therefore, the numerical control device 5 can change the limitation settings such as the motion range and speed of the robot 3, using the safe operation settings which differ between inside and outside of the machine tool 2.

In addition, the robot numerical control commands cause the robot 3 to move to the plurality of work targets, and the safe operation settings may be switched according to the plurality of work targets. Therefore, the numerical control device 5 can change the limitation settings such as the motion range and speed of the robot 3 with respect to the plurality of work targets.

In addition, the safe operation settings may include at least one among a motion range of the robot 3, a 3D model of the robot 3 including the end effector, and a maximum operating speed of the robot 3. The numerical control device 5 can thereby perform the safe operation setting according to the situation of the robot 3.

In addition, the safe operation setting information is stored in the safe operation setting information storage section 541 provided to any one of the numerical control device 5, the robot control device 6 or outside of the numerical control device 5 and robot control device 6. The numerical control device 5 can thereby read the safe operation setting information from the safe operation setting information storage section 541 provided at any location, and perform the safe operation setting.

In addition, according to the present embodiment, the numerical control system 1 includes: the numerical control device 5 which executes a numerical control program for controlling operation of the machine tool 2 and the robot 3; and the robot control device 6 which controls the robot 3 based on the numerical control program, in which the numerical control device 5 includes the analysis unit 52 which analyzes a robot numerical control command in the numerical control program; the safe operation setting selection unit 56 which, in a case of the robot numerical control command analyzed by the analysis unit 52 including a safe operation setting, selects a safe operation setting of the robot numerical control command, and reads the safe operation setting information corresponding to the safe operation setting; and the robot command signal generation unit 55 which generates a robot command signal based on the robot numerical control command and the safe operation setting information, in which the robot control device 6 includes: the input analysis unit 62 which analyzes the robot command signal inputted from the numerical control device 5; the safe operation setting update control unit 68 which, in the case of the robot command signal analyzed by the input analysis unit 62 including a signal corresponding to the safe operation setting information, updates the safe operation setting of the robot based on the signal corresponding to the safe operation setting information; and the servo control unit 67 which executes processing of decelerating or stopping a servomotor of the robot 3, when detecting operation of the robot 3 deviating from the updated safe operation setting.

A numerical control system 1 according to the present embodiment can change the limitation settings such as the motion range and speed of the robot 3 according to the situation, by selecting the safe operation settings of the robot 3 based on the robot numerical control commands in the numerical control program. Therefore, the numerical control system 1 can prevent collision between the robot 3 and the machine tool 2 due to misoperation, programming error, etc. during running of the robot 3 according to the numerical control program.

Although embodiments of the present invention have been described above, the above-mentioned numerical control system 1 can be realized by hardware, software or a combination of these. In addition, the control method performed by the above-mentioned numerical control system 1 can also be realized by hardware, software or a combination of these. Herein, being realized by software indicates being realized by a computer reading and executing a program.

The program can be stored using various types of non-transitory computer readable medium, and supplied to the computer. Non-transitory computer readable medium includes various types of tangible storage media. Examples of non-transitory computer readable media include magnetic media (for example, hard disk drive), magneto-optical recording media (for example, magneto-optical disk) , CD-ROM (Read Only Memory), CD-R, CD-R/W, and semiconductor memory (for example, mask ROM, PROM (Programmable ROM), EPROM (Erasable PROM), flash ROM, RAM (random access memory) ).

Although the present disclosure has been described in detail, the present disclosure is not to be limited to the aforementioned individual embodiments. These embodiments are capable of various additions, substitutions, changes, partial omissions, etc., in a scope not departing from the gist of the present disclosure, or a scope not departing from the spirit of the present disclosure derived from the contents recited in the claims and their equivalents. In addition, these embodiments can be implemented by combining. For example, in the aforementioned embodiments, the order of each operation and the order of each process are shown as examples, and are not to be limited thereto. In addition, the cases in which the numerical values or formulas are being used in the description of the aforementioned embodiments are also similar.

The following notes are further disclosed with respect to the above-described embodiments and modifications.

### (Supplementary Note 1)

A numerical control device for executing a numerical control program for controlling operations of a machine tool and a robot, the numerical control device comprising: an analyzer which analyzes a robot numerical control command in the numerical control program;
a safe operation setting selector which, in a case of the robot numerical control command analyzed by the analyzer including a safe operation setting, selects the safe operation setting in the robot numerical control command, and reads safe operation setting information corresponding to the safe operation setting; and
a robot command signal generator which generates a robot command signal, based on the robot numerical control command and the safe operation setting information,
wherein the robot command signal corresponding to the safe operation setting information is outputted a robot control device controlling the robot, and the safe operation setting is reflected in operation of the robot by the robot control device.

### (Supplementary Note 2)

In the numerical control device as described in Supplementary Note 1, the safe operation setting is switched between inside and outside of the machine tool.

### (Supplementary Note 3)

In the numerical control device as described in Supplementary Note 1, the robot numerical control command causes the robot to move to a plurality of work targets, and the safe operation setting is switched according to the plurality of work targets.

### (Supplementary Note 4)

In the numerical control device as described in Supplementary Note 1, the safe operation setting includes at least one among a motion range of the robot, a 3D model of the robot including an end effector, and a maximum operating speed of the robot.

### (Supplementary Note 5)

In the numerical control device as described in Supplementary Note 1, the safe operation setting information is stored in a safe operation setting information storage provided to any one of the numerical control device, the robot control device, or outside of the numerical control device and the robot control device.

### (Supplementary Note 6)

A numerical control system includes a numerical control device which executes a numerical control program for controlling operations of a machine tool and a robot, and a robot control device which controls the robot based on the numerical control program,
the numerical control device including:
an analyzer which analyzes a robot numerical control command in the numerical control program;
a safe operation setting selector which, in a case of the robot numerical control command analyzed by the analyzer including a safe operation setting, selects the safe operation setting in the robot numerical control command, and reads safe operation setting information corresponding to the safe operation setting; and
a robot command signal generator which generates a robot command signal based on the robot numerical control command and the safe operation setting information, in which the robot control device includes:
an input analyzer which analyzes the robot command signal inputted from the numerical control device;
a safe operation setting update controller which, in a case of the robot command signal analyzed by the input analyzer including a signal corresponding to the safe operation setting information, updates a safe operation setting of the robot, based on the signal corresponding to the safe operation setting information; and
a servo controller which, if detecting operation of the robot deviating from the safe operation setting which was updated, executes processing of decelerating or stopping a servo motor of the robot.

### EXPLANATION OF REFERENCE NUMERALS

1 numerical control system
2 machine tool
3 robot
5 numerical control device
6 robot control device
51 program input unit
52 analysis unit
53 operation control unit
54 storage unit
541 safe operation setting information storage section
55 robot command signal generation unit
56 safe operation setting selection unit
57 data transmitter receiver unit
61 storage unit
62 input analysis unit
63 robot instruction generation unit
64 program management unit
65 path control unit
66 kinematics control unit
67 servo control unit
68 safe operation setting update control unit
69 data transmitter receiver unit

1. A numerical control device for executing a numerical control program for controlling operations of a machine tool and a robot, the numerical control device comprising:
an analyzer that analyzes a robot numerical control command in the numerical control program;
a safe operation setting selector that, in a case of the robot numerical control command analyzed by the analyzer including a safe operation setting, selects the safe operation setting in the robot numerical control command, and reads safe operation setting information corresponding to the safe operation setting; and
a robot command signal generator that generates a robot command signal, based on the robot numerical control command and the safe operation setting information,
wherein the robot command signal corresponding to the safe operation setting information is outputted to a robot control device controlling the robot, and the safe operation setting is reflected in operation of the robot by the robot control. device.

2. The numerical control device according to claim 1, wherein the safe operation setting is switched between inside and outside of the machine tool.

3. The numerical control device according to claim 1, wherein the robot numerical control command causes the robot to move to a plurality of work targets, and the safe operation setting is switched according to the plurality of work targets.

4. The numerical control device according to claim 1, wherein the safe operation setting includes at least one among a motion range of the robot, a 3D model of the robot including an end effector, and a maximum operating speed of the robot.

5. The numerical control device according to claim 1, wherein the safe operation setting information is stored in a safe operation setting information storage provided to any one of the numerical control device, the robot control device, or outside of the numerical control device and the robot control device.

6. A numerical control system including a numerical control device which executes a numerical control program for controlling operations of a machine tool and a robot, and a robot control device which controls the robot based on the numerical control program, the numerical control device comprising:
an analyzer that analyzes a robot numerical control command in the numerical control program;
a safe operation setting selector that, in a case of the robot numerical control command analyzed by the analyzer including a safe operation setting, selects the safe operation setting in the robot numerical control command, and reads safe operation setting information corresponding to the safe operation setting; and
a robot command signal generator that generates a robot command signal based on the robot numerical control command and the safe operation setting information, and
wherein the robot control device comprises:
an input analyzer that analyzes the robot command signal inputted from the numerical control device;
a safe operation setting update controller that, in a case of the robot command signal analyzed by the input analyzer including a signal corresponding to the safe operation setting information, updates a safe operation setting of the robot, based on the signal corresponding to the safe operation setting information; and
a servo controller that, if detecting operation of the robot deviating from the safe operation setting which is updated, executes processing of decelerating or stopping a servo motor of the robot.
